(19) United States
(12) Patent Application Publication
(10) Pub. No.: US 2026/0160388 A1
(43) Pub. Date: Jun. 11, 2026

(54) INSULATING SYSTEM FOR LIQUEFIED GAS STORAGE TANK, AND SHIP COMPRISING SAME

(71) Applicant: Hanwha Ocean Co., Ltd., Geoje-Si, Gyeongsangnam-do (KR)

(72) Inventors: Seong Woo Park, Geoje-si, Gyeongsangnam-do (KR); Jong Hyun Lee, Busan (KR); Yong Seok Lee, Geoje-si, Gyeongsangnam-do (KR); Yoon Sik Hwang, Geoje-si, Gyeongsangnam-do (KR); Sung Gun Park, Seoul (KR)

(21) Appl. No.: 19/127,292

(22) PCT Filed: Dec. 12, 2023
(86) PCT No.: PCT/KR2023/020360

§ 371 Date: May 5, 2025

(30) Foreign Application Priority Data
Dec. 16, 2022 (KR) 10-2022-0177287

(51) Int. Cl. F17C 1/12; F17C 1/00

(52) U.S. Cl. CPC F17C 1/12; F17C 1/002; F17C 2203/0304; F17C 2221/033; F17C 2223/0153; F17C 2260/037; F17C 2270/0105

(57) ABSTRACT

Disclosed herein is an insulation system for liquefied gas storage tanks. The insulation system for liquefied gas storage tanks includes: a primary barrier contacting a liquefied gas; an insulation layer disposed outside the primary barrier; a leakage flow path formed between the primary barrier and the insulation layer and having an outlet through which the liquefied gas leaked from the primary barrier flows; a leakage flow through-channel inserted into the insulation layer, connected to the leakage flow path, and allowing the leaked liquefied gas to pass therethrough; and a partial secondary barrier communicating with the leakage flow through-channel and configured in the form of a pipe, wherein, in the event of leakage from the primary barrier, the leaked liquefied gas is completely vaporized while passing through the partial secondary barrier configured in the form of a pipe.

### TECHNICAL FIELD

The present invention relates to an insulation system for liquefied gas storage tanks and a ship including the same and, more particularly, to an insulation system for liquefied gas storage tanks, which meets leakage standards by completely vaporizing leaked liquefied gas from a storage tank within a pipe type partial secondary barrier, and a ship including the same.

### BACKGROUND ART

Generally, natural gas is transported in a gaseous state through onshore or offshore gas pipelines, or is transported to distant consumers while stored in an LNG carrier in the form of liquefied natural gas (hereinafter, “LNG”).

Storage tanks for liquefied gases, such as liquefied natural gas (LNG) and liquefied hydrogen (LH₂), and transportation means or structures including such storage tanks require a range of fittings and equipment for storage and management of a liquefied gas in the storage tank. Such fittings and equipment are required to meet all conditions, including temperature, pressure, and the like, necessary for storage and management of the liquefied gas and require a design that considers these conditions.

Technologies for storage of liquefied gases are typically classified into membrane tanks and independent tanks in accordance with classification standards specified in the IGC code or onshore tank technology. In particular, independent tanks can be classified into three main types: type A, type B, and type C, depending on the configuration method of a secondary barrier. In particular, for type B independent tanks, the secondary barrier is configured as a partial secondary barrier. Such a partial secondary barrier is required to have liquid tightness.

Type B independent tank used in ships are designed/manufactured in the form of a spherical tank, a prismatic tank, and the like, wherein a partial secondary barrier is installed at a lower end of the tank in the form of a drip tray connected to a channel through which leaked liquefied gas can be discharged.

Such a drip tray is securely installed on a bottom surface of the storage tank to catch a fluid (LNG) flowing downward due to gravity. In addition, the drip tray has an internal space and is installed at one or more locations on the bottom surface of the storage tank to collect a cryogenic fluid flowing downward.

Although such a drip tray serves to temporarily protect a hull for 15 days, the drip tray is required to have an excessively large size to contain a leaked cryogenic fluid in a liquid state during this period. Therefore, there is a need for a practical alternative utilizing the fact that gas tightness is not required.

In addition, when the bottom surface of the storage tank is relatively flat, complexity in a small space increases due to the necessity of installing multiple drip trays.

### DISCLOSURE

### Technical Problem

Embodiments of the present invention are conceived to solve such problems in the art and it is one aspect of the present invention to provide an insulation system for liquefied gas storage tanks, which meets leakage standards by completely vaporizing leaked liquefied gas from a storage tank within a pipe-type partial secondary barrier instead of collecting the leaked liquefied gas using a typical drip tray-type partial secondary barrier.

It is another aspect of the present invention to provide an insulation system for liquefied gas storage tanks, which does not require excessive space for installation of a partial secondary barrier and is free from spatial constraints.

### Technical Solution

In accordance with one aspect of the present invention, there is provided an insulation system for a liquefied gas storage tank, including: a primary barrier contacting a liquefied gas; an insulation layer disposed outside the primary barrier; a leakage flow path formed between the primary barrier and the insulation layer and having an outlet through which the liquefied gas leaked from the primary barrier flows; a leakage flow through-channel inserted into the insulation layer, connected to the leakage flow path, and allowing the leaked liquefied gas to pass therethrough; and a partial secondary barrier communicating with the leakage flow through-channel and configured in the form of a pipe, wherein, in the event of leakage from the primary barrier, the leaked liquefied gas is completely vaporized while passing through the partial secondary barrier configured in the form of a pipe.

The partial secondary barrier may be connected at one end thereof to the leakage flow through-channel and may be formed at the other end thereof with a gas opening to discharge the liquefied gas vaporized within the partial secondary barrier.

The partial secondary barrier may be configured in the form of a pipe having an internal space and may have a shape selected from among a straight line shape, a curved shape, a zigzag shape, a spring shape, and a radial shape to be increased in length.

The partial secondary barrier may be connected in a liquid-tight manner to the leakage flow through-channel by one of welding, threading, or bolting.

The leakage flow through-channel may include one or more leakage flow through-channels disposed at different locations of the liquefied gas storage tank and communicating with the partial secondary barrier.

The insulation system may further include: a connection pipe connecting one leakage flow through-channel to another leakage flow through-channel adjacent thereto in series, and the partial secondary barrier may be connected to a farthest downstream one of the leakage flow through-channels connected to each other in series by the connection pipe.

The insulation system may further include: a connection pipe connecting a corresponding one of the leakage flow through-channels to the partial secondary barrier.

The partial secondary barrier may comprise a pipe formed of a metal capable of serving as a barrier material suitable for the liquefied gas.

In accordance with another aspect of the present invention, there is provided a ship including an insulation system connected to a liquefied gas storage tank.

### Advantageous Effects

Embodiments of the present invention provide an insulation system for liquefied gas storage tanks, which meets leakage standards by completely vaporizing leaked liquefied gas from a storage tank within a pipe-type partial secondary barrier, thereby eliminating the need for installation of a typical drip tray.

In addition, embodiments of the present invention provide an insulation system for liquefied gas storage tanks, especially for type B independent tanks, which does not require excessive space for installation of a partial secondary barrier and is free from spatial constraints.

### DESCRIPTION OF DRAWINGS

FIG. 1 is a cross-sectional view of an installation region of a pipe-type partial secondary barrier in an insulation system for liquefied gas storage tanks according to one embodiment of the present invention.

FIG. 2 shows example views (a), (b), (c), (d), (e), and (f) illustrating various shapes of partial secondary barriers used in the insulation system for liquefied gas storage tanks according to one embodiment of the present invention.

FIG. 3 is a schematic diagram illustrating a coupling structure of the insulation system for liquefied gas storage tanks according to one embodiment of the present invention.

FIG. 4 is a schematic diagram illustrating a coupling structure of the insulation system for liquefied gas storage tanks according to another embodiment of the present invention.

### EMBODIMENTS

The above and other aspects, features, and advantages of the present invention will become apparent from the detailed description of the following embodiments in conjunction with the accompanying drawings. It should be noted that like components will be denoted by like reference numerals throughout the specification. In addition, description of known functions and constructions which may unnecessarily obscure the subject matter of the present invention will be omitted.

It should be understood that the accompanying drawings are provided for the purpose of facilitating understanding of embodiments disclosed in this specification and are not intended to limit the technical concepts disclosed herein. In addition, it should be understood that the present invention encompasses all modifications, equivalents, and substitutions that fall within the spirit and scope of the invention.

In addition, it will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

Herein, the term “liquefied gas” is intended to encompass all gas fuels generally stored in a liquid state, such as LNG, liquefied hydrogen, liquefied nitrogen, LPG, ethylene, and ammonia, and, for convenience of description, may also refer to gas fuels that are not in a liquid state due to heating or pressurization. This definition is equally applicable to boil-off gas. In addition, herein, the term “LNG” may be used in a comprehensive sense, including not only LNG in a liquid state but also LNG in a supercritical state, and the term “boil-off gas” may refer to not only gaseous boil-off gas but also liquefied boil-off gas.

In addition, herein, the terms “primary” and “secondary” are used to distinguish between a function of primarily sealing or insulating a storage tank storing LNG and a function of secondarily sealing or insulating the storage tank.

In addition, as a matter of convention, the term “upper” or “top” applied to elements of a storage tank refers to a direction towards the inside of the tank, regardless of gravitational orientation. Similarly, the term “lower” or “bottom” refers to a direction towards the outside of a storage tank, regardless of gravitational orientation.

Hereinafter, embodiments of the present invention will be described with reference to the accompanying drawings. In each drawing, the same reference numeral denotes the same component.

It should be noted that a ship provided with a liquefied gas storage tank described below includes not only a merchant ship that transports cargo from a starting point to a destination, but also an offshore structure that floats at a specific point at sea and performs specific tasks. In addition, it should be noted that, herein, the term “liquefied gas storage tank” refers to any type of tank that stores liquefied gas.

The present invention may be applied to a type B independent liquefied gas storage tank that includes a secondary barrier formed as a partial secondary barrier and requires liquid-tightness.

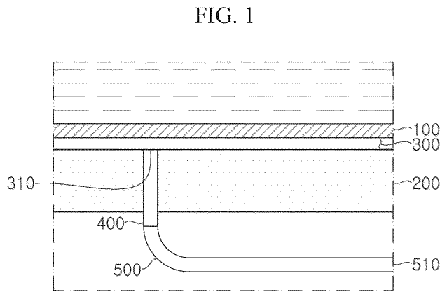

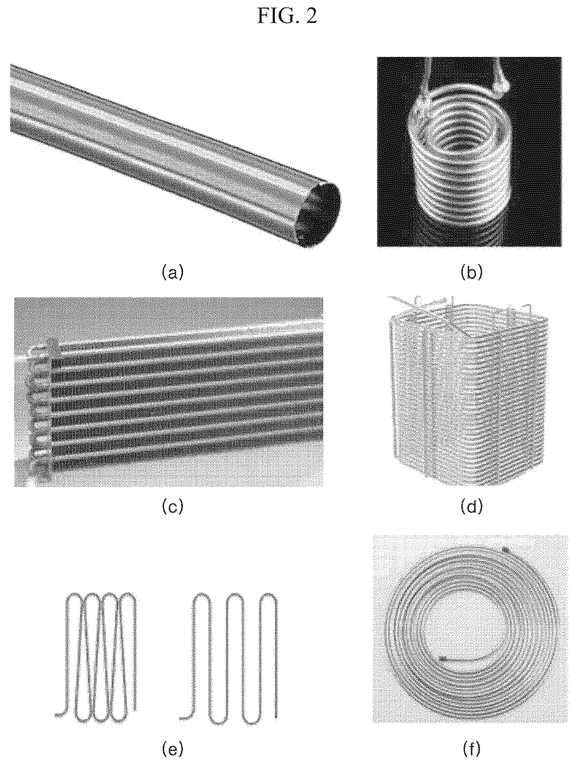

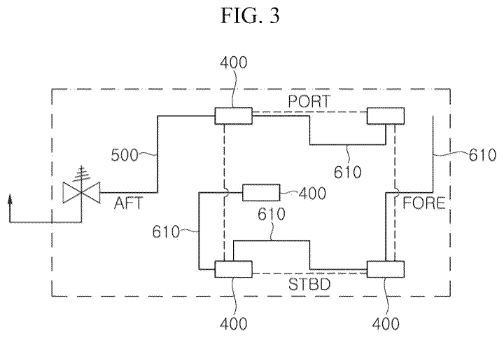

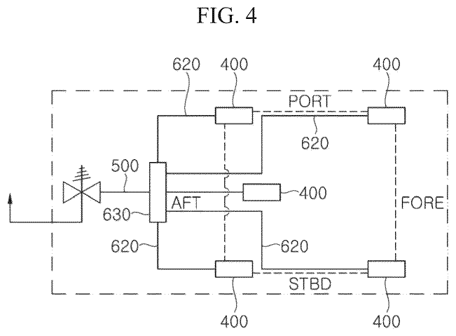

FIG. 1 is a cross-sectional view of an installation region of a pipe-type partial secondary barrier in an insulation system for liquefied gas storage tanks according to one embodiment of the present invention, FIG. 2 shows example views (a), (b), (c), (d), (e), and (f) illustrating various shapes of partial secondary barriers used in the insulation system for liquefied gas storage tanks according to one embodiment of the present invention, FIG. 3 is a schematic diagram illustrating a coupling structure of the insulation system for liquefied gas storage tanks according to one embodiment of the present invention, and FIG. 4 is a schematic diagram illustrating a coupling structure of the insulation system for liquefied gas storage tanks according to another embodiment of the present invention.

Referring to FIG. 1, the insulation system for liquefied gas storage tanks according to this embodiment includes: a primary barrier 100 contacting a liquefied gas; an insulation layer 200 disposed outside the primary barrier 100; a leakage flow path 300 formed between the primary barrier 100 and the insulation layer 200 and allowing the liquefied gas leaked from the primary barrier 100 to flow therethrough; a leakage flow through-channel 400 inserted into the insulation layer 200, connected to the leakage flow path 300, and allowing the leaked liquefied gas to pass therethrough; and a partial secondary barrier 500 communicating with the leakage flow through-channel 400 and configured in the form of a pipe, wherein, in the event of leakage from the primary barrier 100, the leaked liquefied gas is completely vaporized while passing through the partial secondary barrier 500 configured in the form of a pipe.

Specifically, the primary barrier 100 of the insulation system for liquefied gas storage tanks according to the embodiment may be configured in a form that directly contacts and confines the liquefied gas, and may be formed of a metal suitable for characteristics of the liquefied gas, such as aluminum, nickel alloy steel, high manganese steel, stainless steel, and nickel.

The leakage flow path 300 of the insulation system for liquefied gas storage tanks according to the embodiment is formed between the primary barrier 100 and the insulation layer 200 and serves as a passage through which the liquefied gas leaked from the primary barrier 100 flows. Specifically, the leakage flow path 300 provides a space for conveyance of the liquefied gas in a liquid state that leaks from a storage tank due to damage to the primary barrier 100.

In addition, the leakage flow path 300 may have an outlet 310 formed in the direction of the insulation layer 200 to facilitate discharge of the leaked liquefied gas through the leakage flow through-channel 400 described below.

The leakage flow through-channel 400 of the insulation system for liquefied gas storage tanks according to the embodiment may be configured in the form of a small-diameter pipe that is inserted into and through the insulation layer 200 to communicate with the outlet 310 of the leakage flow path 300 and allow passage of the leaked liquefied gas therethrough. Specifically, since the leakage flow through-channel 400 is a channel that penetrates the insulation layer 200 and allows the leaked liquefied gas to flow to the outside of the storage tank therethrough, the leakage flow through-channel 400 may be formed of a material suitable for the characteristics of the liquefied gas. When the liquefied gas is LNG, the leakage flow through-channel is preferably formed of aluminum steel, stainless steel, or the like.

In addition, the leakage flow through-channel 400 of the insulation system for liquefied gas storage tanks according to the embodiment may include one or more leakage flow through-channels 400 inserted into the insulation layer 200 at different locations across the insulation layer 200 to ensure complete discharge of the liquefied gas leaked from the primary barrier 100 surrounding the storage tank.

The partial secondary barrier 500 of the insulation system for liquefied gas storage tanks according to the embodiment may be configured in the form of a pipe that communicates with the leakage flow through-channel 400. Specifically, the partial secondary barrier 500 according to the present invention may be connected at one end thereof to the leakage flow through-channel 400 and may be formed at the other end thereof with a gas opening 510 such that the leaked liquefied gas introduced into the partial secondary barrier 500 through the leakage flow through-channel 400 can be completely vaporized while flowing towards the gas opening 510. Specifically, the partial secondary barrier 500 may be connected in a liquid-tight manner to the leakage flow through-channel 400 by one of welding, threading, or bolting. As the leakage flow through-channel 400 is manufactured in the form of a small-diameter pipe, the partial secondary barrier 500 may also be manufactured in the form of a small-diameter pipe.

In addition, the partial secondary barrier 500 may be manufactured in the form of a long pipe to ensure complete vaporization of the leaked liquefied gas discharged from the leakage flow through-channel 400. That is, by increasing the length of the pipe through which the leaked liquefied gas flows, it is possible to increase an area available for heat transfer. To this end, various shapes as shown in FIG. 2 may be employed for the partial secondary barrier 500.

Dimensions of the partial secondary barrier 500, including length, diameter, and internal surface area, may be determined based on factors such as the diameter of the leakage flow through-channel 400, the size of the storage tank, the loading capacity of the storage tank, and the like.

In addition, the partial secondary barrier 500 of the insulation system for liquefied gas storage tanks according to the embodiment may be formed of a metallic barrier material suitable for the characteristics of the liquefied gas, preferably, a material that can easily transfer heat due to metallic properties thereof.

As shown in FIG. 1, the partial secondary barrier 500 of the insulation system for liquefied gas storage tanks according to the embodiment may be partially formed with a bent portion, such as an “L” shape. This feature enables implementation of a structure allowing the partial secondary barrier 500 to be stably secured to and supported by the leakage flow through-channel 400. However, it should be understood that the position and shape of the partial secondary barrier 500 are not required to be particularly restricted and are appropriately altered or modified to conform to structural characteristics of a ship.

Referring to FIG. 2, the partial secondary barrier 500 according to the present invention may be formed in a shape selected from among a straight line shape ((a) of FIG. 2), a circular spiral coil shape ((b) of FIG. 2), a fin tube shape ((c) of FIG. 2), a rectangular spiral coil shape ((d) of FIG. 2), a zigzag shape ((e) of FIG. 2), and a concentric coil shape ((f) of FIG. 2). However, it should be understood that the present invention is not limited thereto and the partial secondary barrier 500 may have any shape that facilitates heat transfer. The partial secondary barrier 500 may be formed in a circular spiral coil shape, a rectangular spiral shape, or a concentric coil shape and may be arranged in series or in parallel. However, it should be understood that the present invention is not limited thereto and the partial secondary barrier 500 may be arranged in any form that ensures rapid heat transfer.

As such, since the partial secondary barrier 500 according to the present invention is configured in the form of a pipe, it is possible to eliminate the need for a drip tray typically installed to collect leaked liquefied gas, thereby effectively resolving various problems associated with installation of the drip tray (for example, unnecessary use of space in the ship, and the like).

In addition, since the partial secondary barrier 500 according to the present invention is configured in the form of a pipe with a significantly simplified structure compared to typical drip trays, it is possible to implement an insulation system free from spatial constraints. Specifically, a typical drip tray needs to be installed in a limited space due to the necessity of installing an additional insulation means to prevent cooling of nearby wall surfaces, whereas the pipe-type partial secondary barrier 500 according to the present invention can be mounted in a space-saving manner due to the structure allowing the partial secondary barrier 500 to be stably secured to and supported by the leakage flow through-channel 400, thereby enabling implementation of an insulation system free from spatial constraints.

As described above, the insulation system for liquefied gas storage tanks according to the embodiment is configured such that any liquefied gas introduced into the partial secondary barrier 500 is completely vaporized while flowing to the gas opening 510 formed at the other end of the partial secondary barrier 500 before being discharged to the outside. Here, the amount of liquefied gas vaporized can be estimated by calculating the amount of heat penetration into liquefied gas introduced into the partial secondary barrier 500 using the following equation:

$$Leakage rate = Q / ( d \times V \times L ) ( vol . \% / H )$$

In the above equation, Q is the amount of heat penetration into the partial secondary barrier 500, d is the density of leaked liquefied gas, V is the volume of leaked liquefied gas, and L is the latent heat of leaked liquefied gas. Using this equation, it is possible to calculate the amount of heat penetration required to completely vaporize the liquefied gas introduced into the secondary barrier. Furthermore, based on the calculated required amount of heat penetration, it is possible to estimate the amount of liquefied gas completely vaporized and to determine the diameter or length of the partial secondary barrier 500 allowing passage of the liquefied gas therethrough.

In addition, the partial secondary barrier 500 of the insulation system for liquefied gas storage tanks according to the embodiment may be provided at the other end thereof with a pressure relief valve to block or control the flow of the liquefied gas through the partial secondary barrier 500. In addition, the degree of opening of the pressure relief valve may be adjusted using the above equation. Here, the pressure relief valve may be configured to be controlled based on the amount of the liquefied gas introduced into the partial secondary barrier 500.

The insulation system for liquefied gas storage tanks according to the embodiment may further include a connection pipe to completely collect the liquefied gas leaked from the primary barrier 100.

Referring to FIG. 3, the leakage flow through-channel 400 and the partial secondary barrier 500 of the insulation system for liquefied gas storage tanks according to the embodiment may be disposed on a bottom of the storage tank. Particularly, the leakage flow through-channel 400 may be disposed at several locations at a bottom of the storage tank to completely collect the liquefied gas leaked from the storage tank. In addition, the insulation system for liquefied gas storage tanks according to the embodiment may include one or more leakage flow through-channels 400 and one or more connection pipes 610 each connecting a pair of adjacent leakage flow through-channels 400. The connection pipe 610 may be configured to connect a plurality of leakage flow through-channels 400 in series and to convey the liquefied gas to the partial secondary barrier 500 disposed downstream thereof. Leaked liquefied gas discharged through one leakage flow through-channel 400 is partially vaporized while passing through a connection pipe 610 connected to another leakage flow through-channel 400 adjacent thereto and is completely vaporized while passing through the partial secondary barrier 500 connected to a farthest downstream one of the plurality of leakage flow through-channels 400 before being finally discharged to the outside.

FIG. 4 is a schematic view illustrating a coupling structure of an insulation system for liquefied gas storage tanks according to another embodiment of the present invention. In the embodiment described below, components identical or similar to those in the above embodiment will be denoted by the same or similar reference numerals, and detailed description thereof will be omitted, with reference to the description given above.

The leakage flow through-channel 400 of the insulation system for liquefied gas storage tanks according to this embodiment may be coupled to a corresponding connection pipe 620. Specifically, the insulation system for liquefied gas storage tanks according to this embodiment may include one or more leakage flow through-channels 400 each coupled to a corresponding one of one or more connection pipes 620. In addition, the connection pipes 620 connected to the respective leakage flow through-channels 400 may be integrated into a single line to be connected to the partial secondary barrier 500. Alternatively, leaked liquefied gas discharged from the plurality of leakage flow through-channels 400 may be collected in a separate leaked fluid collection device 630 and then delivered to the partial secondary barrier 500.

Consequently, in this embodiment, leaked liquefied gas discharged through the leakage flow through-channel 400 can be partially vaporized while being delivered to the partial secondary barrier 500 through the connection pipe 620 and can be completely vaporized through heat exchange while passing through the partial secondary barrier 500 before being finally discharged to the outside of a hull through a gas opening 510.

In addition to the embodiments described above, the present invention encompasses all embodiments conceived from the combination of two or more of the embodiments or the combination of one or more of the embodiments with known techniques.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit of the invention.

It should be understood that any minor variations or alterations to the present invention are included within the scope of the invention, and the scope of protection of the invention will be clarified by the appended claims.

1. An insulation system for a liquefied gas storage tank, comprising:
a primary barrier contacting a liquefied gas;
an insulation layer disposed outside the primary barrier;
a leakage flow path formed between the primary barrier and the insulation layer and having an outlet through which the liquefied gas leaked from the primary barrier flows;
a leakage flow through-channel inserted into the insulation layer, connected to the leakage flow path, and allowing the leaked liquefied gas to pass therethrough; and
a partial secondary barrier communicating with the leakage flow through-channel and configured in the form of a pipe,
wherein, in the event of leakage from the primary barrier, the leaked liquefied gas is completely vaporized while passing through the partial secondary barrier configured in the form of a pipe.

2. The insulation system according to claim 1, wherein the partial secondary barrier is connected at one end thereof to the leakage flow through-channel and is formed at the other end thereof with a gas opening to discharge the liquefied gas vaporized within the partial secondary barrier.

3. The insulation system according to claim 1, wherein the partial secondary barrier is configured in the form of a pipe having an internal space and has a shape selected from among a straight line shape, a curved shape, a zigzag shape, a spring shape, and a radial shape to be increased in length.

4. The insulation system according to claim 1, wherein the partial secondary barrier is connected in a liquid-tight manner to the leakage flow through-channel by one of welding, threading, or bolting.

5. The insulation system according to claim 1, wherein the leakage flow through-channel comprises one or more leakage flow through-channels disposed at different locations of the liquefied gas storage tank and communicating with the partial secondary barrier.

6. The insulation system according to claim 1, wherein
the leakage flow through-channel comprises one or more leakage flow through-channels,
the insulation system further comprises: a connection pipe connecting one leakage flow through-channel to another leakage flow through-channel adjacent thereto in series, and
the partial secondary barrier is connected to a farthest downstream one of the leakage flow through-channels connected to each other in series by the connection pipe.

7. The insulation system according to claim 1, wherein
the leakage flow through-channel comprises one or more leakage flow through-channels, and
the insulation system further comprises: a connection pipe connecting a corresponding one of the leakage flow through-channels to the partial secondary barrier.

8. The insulation system according to claim 1, wherein the partial secondary barrier comprises a pipe formed of a metal capable of serving as a barrier material suitable for the liquefied gas.

9. A ship comprising the insulation system for the liquefied gas storage tank according to claim 1.
